(19) United States
(12) Patent Application Publication
(10) Pub. No.: US 2012/0016535 A1
(43) Pub. Date: Jan. 19, 2012

(54) SYSTEM AND METHOD FOR PROVIDING REMOTE MAINTENANCE SERVICE FOR SYSTEMS ON A SHIP

(75) Inventors: Kwang Il LEE, Daejeon (KR); Jun Hee PARK, Daejeon (KR); Hae Sook JEON, Daejeon (KR); Kyeong Deok MOON, Daejeon (KR)

(73) Assignee: Electronics and Telecommunications Research Institute, Daejeon (KR)

(21) Appl. No.: 13/183,778

(22) Filed: Jul. 15, 2011

(30) Foreign Application Priority Data
Jul. 15, 2010 (KR) 10-2010-0068598
Feb. 21, 2011 (KR) 10-2011-0015096

(51) Int. Cl. G06F 17/00

(52) U.S. Cl. 701/2; 701/1

(57) ABSTRACT

Disclosed are a system and a method for providing a remote maintenance service for system on a ship. A system for providing a remote maintenance service for system on a ship according to an aspect of the present invention includes: determining a target device and contents of a service through a user interface of a web browser in response to a request for a maintenance service from a user through the user interface; providing, by a local service device, the maintenance service for the target device configuring a transmission/reception maintenance message in accordance with the contents of the service and transmitting the transmission/reception maintenance message to the local service device in the ship where the target device is installed; and receiving a performing result of the maintenance service from the local service device.

### CROSS-REFERENCE TO RELATED APPLICATIONS

This application claims priority under 35 U.S.C. §119 to Korean Patent Application No. 10-2010-0068598, filed on Jul. 15, 2010 and No. 10-2011-0015096, filed on Feb. 21, 2011 in the Korean Intellectual Property Office, the disclosure of which is incorporated herein by reference in its entirety.

### TECHNICAL FIELD

The present invention relates to a remote maintenance for systems on a ship, and more particularly, to a system and a method for providing a remote maintenance service that can provide a maintenance service for systems on a ship.

### BACKGROUND

In general, ships sailing the ocean are high-priced and there is a high possibility that a simple fault may cause a big accident. Therefore, high degree of stability is required for a vessel body, and devices and systems installed therein.

Specifically, ships in voyage are not easily accessible by maintenance personnel when the fault occurs in the sailing ship and the onboard systems are very various and complicated. Thus, it needs a lot of time and efforts for the maintenance personnel to access the ship and diagnose the fault, such that a simple fault may cause the big accident.

In order to solve the problem, in recent years, a remote monitoring service or a maintenance service is applied to the ship and the ship devices. However, related art of the network based remote monitoring and maintenance services provided services limited to products of the same company. Therefore, related, art of the remote monitoring and maintenance services were not effective with respect to a ship environment to which various products of different providers are used.

### SUMMARY

An exemplary embodiment of the present invention provides a system for providing a remote maintenance service for systems on a ship, including: a local service device providing a maintenance service to a plurality of ship devices installed in the ship and reporting a performing result of the maintenance service; and a global service server in response to a request for a maintenance service for a ship device among the plurality of ship devices from a user through a web browser, transmitting a maintenance message including the maintenance service to the local service device where the ship device is installed and receiving the performing result of the maintenance service.

Another exemplary embodiment of the present invention provides a method for providing a remote maintenance service of a global service server, the method including: determining a target device and contents of a service through a user interface of a web browser in response to a request for a maintenance service from a user through the user interface; providing, by a local service device, the maintenance service for the target device configuring a transmission/reception maintenance message in accordance with the contents of the service and transmitting the transmission/reception maintenance message to the local service device in the ship where the target device is installed; and receiving a performing result of the maintenance service from the local service device.

Yet another exemplary embodiment of the present invention provides a method for providing a remote maintenance service of a local service device, the method including: receiving, by a global service server, a request for a maintenance service from a user which accesses the global server through a web browser to determine a target device and a service content through a user interface of the web browser and configuring a transmission/reception maintenance message in accordance with the service content and transmitting the transmission/reception maintenance message to a local service device in a ship where the target device is installed, and receiving and analyzing, by the local service device, the transmission/reception maintenance message and reconfiguring the transmission/reception maintenance message as a control command to control the target device; and, providing, by the local service device, the maintenance service controlling the target device according to the control command and reporting a performing result of the maintenance service.

Other features and aspects will be apparent from the following detailed description, the drawings, and the claims.

### BRIEF DESCRIPTION OF THE DRAWINGS

FIG. 1 is a configuration diagram showing a system for providing a remote maintenance service for systems on a ship according to an exemplary embodiment of the present invention.

FIG. 2 is a flowchart showing a method for providing a remote maintenance service according to an exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

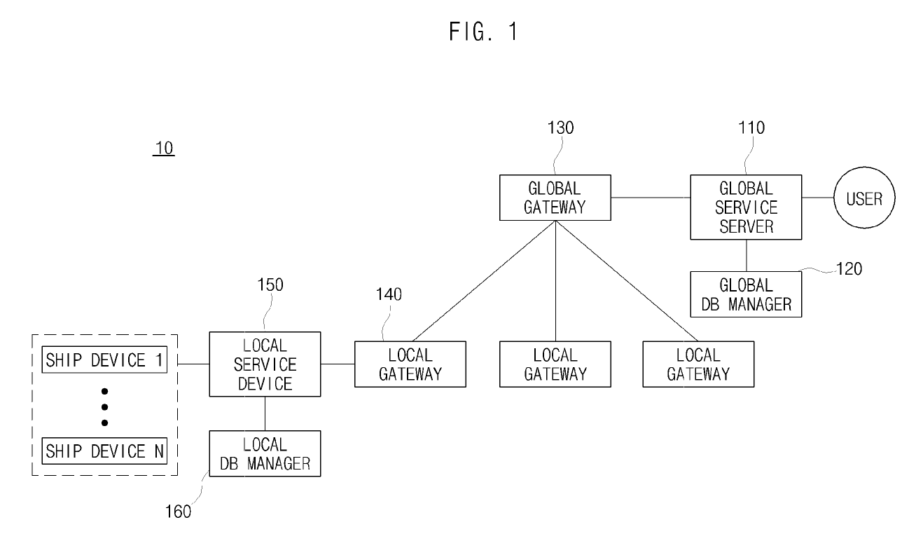

Hereinafter, exemplary embodiments of the present invention will be described, in detail with reference to the accompanying drawings. FIG. 1 is a configuration diagram showing a system for providing a remote maintenance service for systems on a ship according to an exemplary embodiment of the present invention.

As shown in FIG. 1, a system 10 for providing a remote maintenance service for systems on a ship according to an exemplary embodiment of the present invention includes a global service server 110, a global DB manager 120, a global gateway 130, at least one of local gateways 140, a local DB manager 160, and at least one of local service devices 150.

Herein, the global service server 110 and the global gateway 130 transmit a maintenance message to a plurality of local gateways 140 and a plurality of local service devices 150 outside a ship, however, the local gateways 140 and each of the local service devices 150 are installed in each of the plurality of ships, respectively. Thus, the local gateways 140 and the local service devices 150 are equal to or more than the global service servers 110 or the global gateways 130.

A user accesses the global service server 110 through a web browser in user terminal and requests the maintenance service for the ship device to the global service server 110 through a user interface of the web browser. Herein, the user terminal may access the global service server 110 through a web server and in this case, the web server and the global service server 110 may be used for each company and shared by a plurality of agreed companies.

Specifically, when the user initially accesses the global service server 110, the user receives a right of using the maintenance service through registration of an account and a password. In this case, the right for each user may be differentially granted according to a user affiliation and a user grade.

The user additionally inputs information on a ship device to be maintained or detailed contents of the maintenance service through a user interface provided by the global service server 100.

The global service server 110 grants the right for the maintenance service to a user who initially accesses the global service server 110 through a registration procedure of the user account.

In response to a request for the maintenance service from the user, the global service server 110 verifies whether the user requesting the maintenance service has the right. And the global service server 110 configures only a request from the user having the right as the maintenance message and transmits the request to a destination. On the contrary, the global service server 110 notifies to a user not having the right that the user does not have the right and does not provide even the maintenance service.

The global service server 110 configures a group of correlated messages, that is, a transaction for performing one operation corresponding to the user request using information required for the maintenance service stored in the global DB manager 120. In addition, the global service server 110 converts the transaction into a format of a message or a file and stores the converted transaction in the global DB manager 120, and transfers the stored transaction to the global gateway 130. Hereinafter, the case in which the global service server 110 stores and transfers the transaction in the message format (hereinafter, referred to as the ‘maintenance message’) will be described as an example.

Herein, the maintenance message is a message of a protocol in accordance with a communication method between the global service server 110 and the global gateway 130. In addition, the maintenance message includes an identifier uniquely allocated to the maintenance message, positional information of the ship device to be maintained, profile information of the ship device, detailed contents or execution procedures of the maintenance service, and the like.

Meanwhile, the identifier may be an identifier which can be analyzed by all of the plurality of local service devices 150 and a service request identifier which can be identified by only a predetermined industrial device. In this case, the local service device 150 determines the maintenance message as a type-length-value type, a previously defined data structure, a simple character string, and a simple separator. In addition, a performing result of the maintenance service may also be reported by using the type-length-value type, the previously defined data structure, the simple character string, and the simple separator.

The global DB manager 120 stores the information required for the maintenance service and provides the information according to the request from the global service server 110, and stores the maintenance message configured by the global service server 110. Herein, the information required for the maintenance service includes user information, related company information, positional information of the ship and ship device, functional information, a profile, manufacturer information, equipment related company information, shipowner information, or the like.

When the global gateway 130 receives the maintenance message, the global gateway 130 verifies the local gateway 140 of a destination address to be transmitted from the maintenance message and transmits the maintenance message to the local gateway 140 connected with the local service device 150 of the destination address.

The plurality of local gateways 140 and the global gateways 130 may be connected through a communication channel in which stability or reliability is equal to or higher than a predetermined reference value.

Meanwhile, when the global gateway 130 is disconnected from the local gateway 140 while transmitting the maintenance message, the global gateway 130 requests a maintenance support to a gateway maintenance company to solve the connection problem. In this case, the global gateway 130 transmits a message transmission error to the global service server 110 to allow the global service server 110 or the user to request the maintenance support.

The local gateway 140 is connected with the local service device 150 in the ship and when receiving a maintenance message, the local gateway 140 transfers the maintenance message to the local service device 150. And the local gateway 140 receives the performing result of the maintenance service from the local service device 150 and transfers the performing result to the global gateway 130. In this case, when the local gateway 140 is disconnected from the global gateway 130 while transmitting the performing result of the maintenance message, the local gateway 140 notifies the disconnection to the maintenance company to solve the connection problem.

Herein, the global gateway 130 and the local gateway 140 may transmit and receive the maintenance message through satellite communications or mobile communications.

The local service device 150 is installed in the ship, and is connected with the ship devices through various interfaces.

The local service device 150 analyzes the ship device to be maintained and the contents of the maintenance service from the maintenance message and converts the maintenance message into a command which can be executed by the determined ship device to perform the maintenance service determined for the determined ship device. Herein, the maintenance service may be monitoring, set-up changing, resetting, verification of a maintenance history, execution of a predetermined function or, control of the ship device.

For example, In response to a request for monitoring of the ship device, the local service device 150 continuously verifies a performed service state of the ship device or occurrence of a predetermined event and may continuously report the performed service state of the ship device or the occurrence of the predetermined event to the user through the local gateway 140, the global gateway 130, and the global service server 110.

The local service device 150 reports the performing result of the maintenance service to the global service server 110 in the message or file format. Thereafter, when the global service server 110 judges that the state of the ship device is erroneous, the global service server 110 provides a service to send maintenance personnel or guide an emergency measure.

The local DB manager 160 stores the state of the ship device determined by the local service device 150 and the maintenance history information or the basic information of the ship and provides the state of the ship device determined by the local service device 150 and the maintenance history information or the basic information of the ship to the local service device 150 or the global DB manager 120 according to the request.

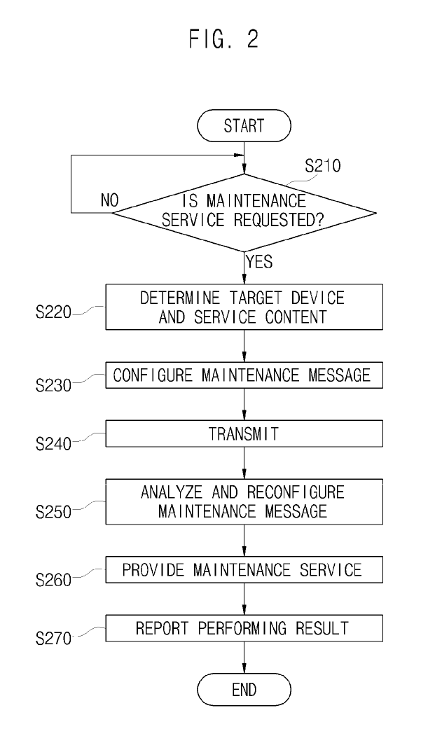

Hereinafter, referring to FIG. 2, a method for providing a remote maintenance service according to an exemplary embodiment of the present invention will be described. FIG. 2 is a flowchart showing a method for providing a remote maintenance service according to an exemplary embodiment of the present invention.

Referring to FIG. 2, a global service server 110 verifies whether a user having a right of accessing a user interface for a maintenance service through a web browser (S210), in this case, the global service server 110 grants the right to a user who initially accesses the global service server 110 through account registration and provides the user interface to only the user having the right.

The global service server 110 determines a target device and contents of the maintenance service in accordance with user input through the user interface (S220).

The global service server 110 configures a maintenance message corresponding to the contents of the maintenance service for the target device using information required for a previously stored maintenance service (S230).

The global service server 110 transmits the maintenance message to the local service device 150 where the target device is installed, through the global gateway 130 and the local gateway 140 (S240). In this case, the global gateway 130 determines the local gateway 140 using positional information of the target device in the maintenance message.

When receiving the maintenance message, the local service device 150 analyzes the received maintenance message and reconfigures the analyzed maintenance message into a control command to control the target device (S250).

The local service device 150 provides the requested maintenance service monitoring or controlling the target device according to the control command (S260).

In addition, the local service device 150 reports a performing result of the maintenance service to the global service server 110 (S270).

As such, according to the exemplary embodiments of the present invention, the local service device executes the maintenance message generated by the maintenance server through interfaces of the local service device in the ship to provide the maintenance service.

Further, if information required to provide the maintenance service is merely provided regardless of a manufacturer or a specification of the ship device, the exemplary embodiments of present invention can provide the maintenance service.

In addition, the exemplary embodiments of the present invention can be easily implemented by adding a local gateway and a local service device to the inside of a previously constructed ship.

A number of exemplary embodiments have been described above. Nevertheless, it will be understood that various modifications may be made. For example, suitable results may be achieved, if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for providing a remote maintenance service for systems on a ship, comprising:
a local service device providing a maintenance service to a plurality of ship devices installed in the ship and reporting a performing result of the maintenance service; and
a global service server in response to a request for a maintenance service for a ship device among the plurality of ship devices from a user through a web browser, transmitting a maintenance message including the maintenance service to the local service device where the ship device is installed and receiving the performing result of the maintenance service.

2. The system of claim 1, wherein the global service server grants a right of using the maintenance service to the user through a registration procedure when the user initially accesses the global service server and provides the maintenance service to the user having the right.

3. The system of claim 1, wherein, when the global service server receives user selection about the ship device to be maintained or contents of the maintenance service, the global service server configures the maintenance message using a maintenance service information in accordance with the user selection among previously stored maintenance service information.

4. The system of claim 1, wherein the local service device is installed in each the ships; and
the system further comprises a plurality of local gateways installed in each of the plurality of ships, respectively and connected with each of the plurality of local service devices; and
a global gateway verifying a destination address in the maintenance message when receiving the maintenance message and transmitting the maintenance message to the local gateway corresponding to the destination address among the plurality of local gateways.

5. The system of claim 4, wherein the plurality of local gateways and the global gateway transmit and receive the maintenance message and the performing result through a satellite communication network or a mobile communication network.

6. The system of claim 4, wherein when an error occurs at the time of transmitting the maintenance message or the performing result, at least one gateway of the plurality of local gateways and the global gateway notifies the error to the user.

7. The system of claim 4, wherein the plurality of local gateways and the global gateway are connected through a communication channel in which stability or reliability is equal to or higher than a predetermined reference value.

8. The system of claim 4, wherein the global service server configures the maintenance message including at least one of an identifier uniquely allocated to the maintenance message, positional information of the local gateway, a profile of the at least one ship device, and a detailed content and an execution procedure of the maintenance service.

9. The system of claim 1, wherein the local service device determines the at least one ship device to which the maintenance service is provided and the contents of the maintenance service analyzing the maintenance message and provides the maintenance service monitoring or controlling the at least one ship device.

10. The system of claim 1, wherein the maintenance service includes at least one of a monitoring, set-up changing, resetting, verification of a maintenance history, execution of a predetermined function, and control of the ship device.

11. A method for providing a remote maintenance service of a global service server, the method comprising:
determining a target device and contents of a service through a user interface of a web browser in response to a request for a maintenance service from a user through the user interface;
providing, by a local service device, the maintenance service for the target device configuring a transmission/reception maintenance message in accordance with the contents of the service and transmitting the transmission/reception maintenance message to the local service device in the ship where the target device is installed; and
receiving a performing result of the maintenance service from the local service device.

12. The method of claim 11, wherein the maintenance service includes at least one of a monitoring, set-up changing, resetting, verification of a maintenance history, execution of a predetermined function, and control of a ship device.

13. The method of claim 1 further comprising:
verifying whether the user has aright of using the maintenance service; and
notifying that the maintenance service is not provided to a user who does not have the right.

14. The method of claim 11, wherein the receiving the performing result includes determining whether repairing of the target device is required using the performing result; and supporting the repairing of the target device when the repairing is required.

15. The method of claim 11, wherein the providing includes transmitting and receiving the transmission/reception maintenance message through a satellite communication network or a mobile communication network by a gateway connected with the local service device and a gateway connected with the global service server.

16. A method for providing a remote maintenance service of a local service device, the method comprising:
receiving, by a global service server, a request for a maintenance service from a user which accesses the global server through a web browser to determine a target device and a service content through a user interface of the web browser and configuring a transmission/reception maintenance message in accordance with the service content and transmitting the transmission/reception maintenance message to a local service device in a ship where the target device is installed, and receiving and analyzing, by the local service device, the transmission/reception maintenance message and reconfiguring the transmission/reception maintenance message as a control command to control the target device; and
providing, by the local service device, the maintenance service controlling the target device according to the control command and reporting a performing result of the maintenance service.

17. The method of claim 16, wherein the target device includes at least one of a ship device in the ship and a system controlling the ship.

18. The method of claim 16, further comprising reporting a monitoring report for the target device at a predetermined cycle when the maintenance service is monitoring the target device.

19. The method of claim 16, wherein the transmitting includes transmitting and receiving the transmission/reception maintenance message through a satellite communication network or a mobile communication network by a gateway connected with the local service device and a gateway connected with the global service server.
